(19) United States
(12) Patent Application Publication
(10) Pub. No.: US 2025/0123480 A1
(43) Pub. Date: Apr. 17, 2025

(54) MOLDED STRUCTURE

(71) Applicant: Stanley Electric Co., Ltd., Tokyo (JP)

(72) Inventors: Hideo TAKAGI, Tokyo (JP); Hiroyuki TOGAWA, Tokyo (JP); Shinichi TANAKA, Tokyo (JP)

(21) Appl. No.: 18/689,652

(22) PCT Filed: Sep. 9, 2022
(86) PCT No.: PCT/JP2022/033876

§ 371 Date: Mar. 6, 2024

(30) Foreign Application Priority Data
Sep. 22, 2021 (JP) 2021-154718

(51) Int. Cl. G02B 27/00

(52) U.S. Cl. CPC G02B 27/0006

(57) ABSTRACT

A groove element includes a first groove region, a conical groove region having conical shape, and a second groove region with V shape cross section. At one end of the first groove region, a groove wall surface circumscribes conical surface from both sides, the conical surface having similar shape to the conical groove region and a size smaller than the conical groove region, and at the other end, groove wall surface circumscribes the conical groove region from both sides. At one end of the second groove region, groove wall surface circumscribes conical surface from both sides, and at the other end, groove wall surface circumscribes conical groove region from both sides. The first and second groove regions have same depth as the conical groove region at connection part connected to the conical groove region and have same depth as the conical surface at one end and the other end.

This application is a U.S. National Stage Application under 35 U.S.C § 371 of International Patent Application No. PCT/JP2022/033876 filed Sep. 9, 2022, which claims the benefit of priority under 35 U.S.C. § 119 to Japanese Patent Application No. 2021-154718 filed Sep. 22, 2021, the disclosures of all of which are hereby incorporated by reference in their entireties.

### TECHNICAL FIELD

The present invention relates to a molded structure body, particularly a molded structure body in which a fine groove is formed on a surface of a base material.

### BACKGROUND ART

In the related art, in order to prevent the surface of the optical component or the like from fogging, it has been known to apply an anti-fog coating to the surface of the component or to form a fine groove on the surface of the component for forming a water film of water droplets.

For example, Patent Literature 1 discloses a molded structure body that exhibits hydrophilicity, anti-fogging properties, and self-cleanability only by the structure of the surface of the base material without relying on spraying, coating of a thin film, or an electrical means.

In addition, Patent Literature 2 discloses a bathroom mirror, where a means for guiding excess water exceeding an allowable amount that can be held as a water film is provided on a surface of a hydrophilic mirror.

In addition, Non-Patent Literature 1 discloses a study on dynamics associated with the shapes of the fine groove on the surface of the opening, the contact angle, and the capillary flow.

### CITATION LIST

### Patent Literatures

Patent Literature 1: Japanese Patent Application Laid-Open No. 2009-193002
Patent Literature 2: Japanese Patent Application Laid-Open No. 2000-279296

### Non-Patent Literature

Non-Patent Literature 1: R. R. Rye et al., Capillary Flow in Irregular Surface Grooves, Langmuir 1998, 14, 3937-3943

### SUMMARY OF INVENTION

### Technical Problem

However, in the anti-fog coating, the amount of water to be held is limited, and the effect of discharging liquid droplets is not obtained either. In addition, in the longitudinal groove processing in the related art, which uses the capillary phenomenon, there is a problem that a pinning effect of water droplets is exhibited and thus the liquid droplets do not move. In addition, in a case where the liquid droplets do not move, there is a problem in that large water droplets that are capable of being visually recognized are formed.

The present invention has been made in consideration of the above-described points, and an object of the present invention is to provide a molded structure body such as an optical component that has a high effect of discharging liquid droplets and has an excellent anti-fogging effect. In addition, it is possible to provide a molded structure body having a groove structure that enables liquid droplets to be efficiently moved in any direction.

### Solution to Problem

A molded structure body according to one embodiment of the present invention includes:
a base material; and
at least one groove obtained by linking a plurality of groove elements each having a first end part and a second end part, on a surface of the base material in a row such that the first end part of one groove element is sequentially connected to the second end part of another groove element,
in which each of the groove elements consists of a first groove region in which a groove wall surface has a quadrangular shape and a cross section has a V shape, a conical groove region in which a groove wall surface has a conical shape, and a second groove region in which a groove wall surface has a quadrangular shape and a cross section has a V shape,
in the first groove region, at one end which is the first end part, the groove wall surface circumscribes a conical surface from both sides, the conical surface having a shape similar to the conical groove region and having a size smaller than the conical groove region, and at the other end, the groove wall surface circumscribes the conical groove region from both sides,
in the second groove region, at one end which is the second end part, the groove wall surface circumscribes the conical surface from both sides, and at the other end, the groove wall surface circumscribes the conical groove region from both sides,
the first groove region and the second groove region have the same depth as the conical groove region at a connection part connected to the conical groove region and have the same depth as the conical surface at the first end part and the second end part, and
in a case where a direction from a center of a bottom surface of the conical groove region toward a center of a bottom surface of the conical surface of the first end part is denoted as a first direction,
a direction from a center of a bottom surface of the conical surface of the second end part toward the center of the bottom surface of the conical groove region is denoted as a second direction,
a length of the first groove region in the first direction and a length of the second groove region in the second direction are respectively denoted as L1 and L2,
a diameter of the bottom surface of the conical groove region and a diameter of the bottom surface of the conical surface on the surface of the base material are respectively denoted as W1 and W2, and
a depth of the conical groove region and a depth of the conical surface are respectively denoted as D1 and D2, the groove element satisfies,

$$L 1 < L 2 , \qquad Expression ( 1 )$$

$$W 1 > W 2 , \qquad Expression ( 2 )$$

$$D 1 > D 2 , and \qquad Expression ( 3 )$$

$$( D 2 / W 2 ) > ( D 1 / W 1 ) . \qquad Expression ( 4 )$$

### BRIEF DESCRIPTION OF DRAWINGS

FIG. 1A is a view illustrating three tensions in a stationary state, a surface tension of a solid, a surface tension of a liquid, and an interface tension between a solid and a liquid.

FIG. 1B is a view illustrating a relationship between a groove structure and liquid droplet movement.

FIG. 2 is a perspective view schematically illustrating a first groove region R1, a second groove region R2, and a conical groove region CR of a groove element GE according to a first embodiment of the present invention.

FIG. 3A is a top view of the groove element GE of a groove GR provided on a surface of a base material 11 in a case where the groove element GE is viewed in a direction perpendicular to the base material 11.

FIG. 3B is a view schematically illustrating a side surface of the groove in a case where the groove element GE illustrated in FIG. 3A is viewed in a −y direction.

FIG. 3C is a view schematically illustrating a cross section of the groove in a case where the groove element GE is viewed in a −x direction.

FIG. 4A is a top view schematically illustrating an upper surface of a molded structure body 10 according to the first embodiment.

FIG. 4B is a partially enlarged view of a part of the groove GR formed on the surface of the molded structure body 10.

FIG. 5A is a schematic top view of the first groove region R1, the second groove region R2, and the conical groove region CR of the groove element GE according to a second embodiment in a case of being viewed in a direction perpendicular to the base material 11 (in a case of being viewed from the upper surface).

FIG. 5B is a top view illustrating a connection form in a case where a groove element GE2 according to the second embodiment and a groove element GE1 according to the first embodiment are connected to each other.

FIG. 5C is a top view illustrating a connection form in which two groove elements GE1 are connected to each other.

FIG. 6A is a top view schematically illustrating a groove structure 22 of Example 1 (Ex. 1).

FIG. 6B illustrates observation images obtained by observing a change of a water droplet dropped from a nozzle NZ on the groove structure 22 of Example 1 with a camera of a contact angle meter in an elongation direction (x direction) of the groove GR and a direction (the y direction) perpendicular to the elongation direction.

FIG. 6C is a graph illustrating the measurement results of the contact angles of water droplet end parts AQ1 and AQ3 with respect to an elapsed time LT after the dropping of the water droplet, in Example 1.

FIG. 7A is a top view schematically illustrating a groove structure 22 of Example 2 (Ex. 2).

FIG. 7B illustrates observation images obtained by observing a change of a water droplet dropped from a nozzle NZ on the groove structure 22 of Example 2 with a camera.

FIG. 7C is a graph illustrating the measurement results of the contact angles of water droplet end parts AQ1 and AQ3 with respect to the elapsed time LT after the dropping of the water droplet, in Example 2.

FIG. 8A is a top view schematically illustrating a groove structure 22 of Example 3 (Ex. 3).

FIG. 8B illustrates observation images obtained by observing a change of a water droplet dropped from a nozzle NZ on the groove structure 22 of Example 3 with a camera.

FIG. 8C is a graph illustrating the measurement results of the contact angles of water droplet end parts AQ1 and AQ3 with respect to the elapsed time LT after the dropping of the water droplet, in Example 3.

FIG. 9 is a top view schematically illustrating a groove structure 32 of Example 4 (Ex. 4).

FIG. 10A is a top view schematically illustrating a connection form of a groove element GE3 according to a third embodiment.

FIG. 10B is a top view schematically illustrating two grooves GR1 and GR2 which are branched and bound by using the groove element GE3.

### DESCRIPTION OF EMBODIMENTS

Hereinafter, preferred embodiments of the present invention will be described; however, these embodiments may be appropriately modified and combined. In addition, in the following description and the accompanying drawings, substantially the same or equivalent parts will be described with the same reference numerals.

### [Liquid Droplet Movement in Fine Groove Due to Capillary Phenomenon]

Whether or not liquid droplets are able to move in the groove in which the capillary phenomenon has occurred is determined by the following expression.

### [Math. 1]

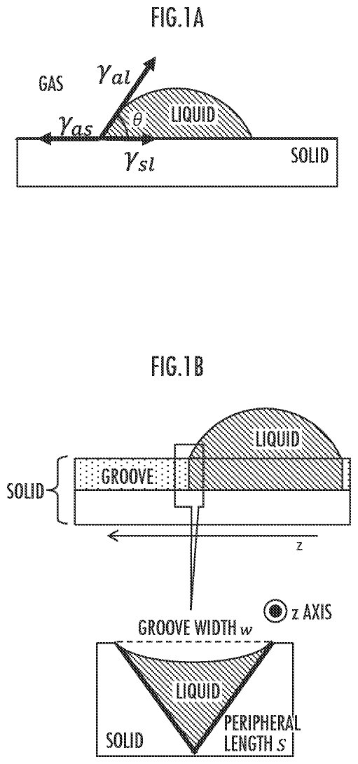

FIG. 1A is a view illustrating three tensions in a stationary state, a surface tension γₐₛ of a solid, a surface tension γₐₗ of a liquid, and an interface tension γₛᵢ between a solid and a liquid. In addition, FIG. 1B is a view illustrating a relationship between a groove structure and liquid droplet movement.

With reference to FIG. 1A, three tensions of the surface tension γₐₛ of the solid (the interface tension between the gas and the solid), the surface tension γₐₗ of the liquid (the interface tension between the gas and the liquid), and the interface tension γₛᵢ between the solid and the liquid work at an end point of a liquid droplet, and the following expression (Young's expression) is established in the stationary state.

γₐₛ=γₐₗ·cos θ+γₛₗ

The extension of Young's expression in the groove part will be described below with reference to FIG. 1B and Non-Patent Literature 1.

Since the surface tension (surface free energy) is an energy required for a movement per unit area, the work in a case where a specimen having a surface tension γ moves by an infinitesimal surface area do is expressed by the following expression.

dW=γdσ

In a case of using an infinitesimal area ΔAₛₗ between a solid and a liquid and an infinitesimal area ΔAₐₗ between a gas and a liquid, the energy change is expressed as follows.

$$Δ E = ( {γ}_{sl} - {γ}_{as} ) Δ {A}_{sl} + {γ}_{al} Δ {A}_{al} = {γ}_{al} ( Δ {A}_{al} - Δ {A}_{sl} cos θ )$$

In a case of such a groove structure as in FIG. 1B, the infinitesimal area is calculated as follows from an outer peripheral length S of a groove, a groove width w, and an infinitesimal length Δz in the depth direction.

ΔAₛₗ≈SΔz

ΔAₐₗ≈wΔz

From the above, a force F_{γ} applied to an end point of a water droplet is defined as follows.

$$\begin{matrix}Δ E = {γ}_{al} ( w Δ z - S \cdot cos θΔ z ) \\ {F}_{γ} = - dE / dz = {γ}_{al} ( S \cdot cos θ - w )\end{matrix}$$

It is noted that in Young's expression and the extended Young's expression which are described above, θ is an equilibrium contact angle. In addition, the outer peripheral length S is the total length or arc length of the outer periphery of the groove in the cross section of the groove.

### First Embodiment

As described above, it is known that the ease of movement of the fluid in the groove is associated with the groove width W on the surface of the base material and the outer peripheral length S of the groove in the cross section perpendicular to the axis of the groove regardless of the groove shape.

The inventors of the present application assumed that in a case of providing a change in the ease of movement in the axial direction of the groove, it would be possible to specify the moving direction, and carried out studies.

### (1) Structure

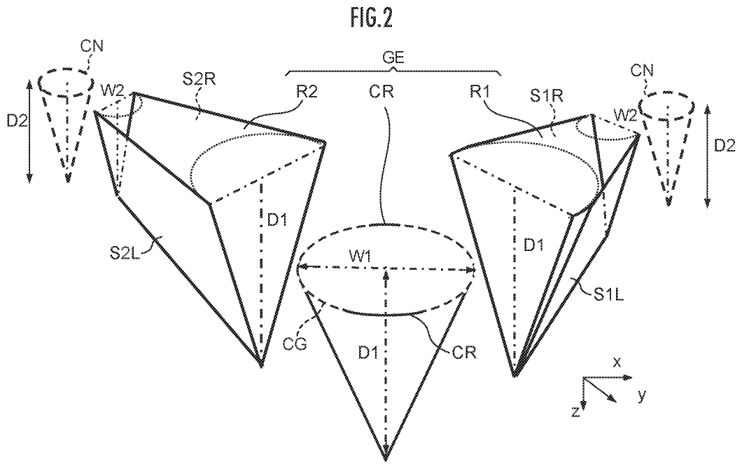

FIG. 2 is a perspective view schematically illustrating a first groove region R1, a second groove region R2, and a conical groove region CR of a groove element GE according to a first embodiment of the present invention. It is noted that for easy understanding, the first groove region R1, the second groove region R2, and the conical groove region CR are illustrated separately in the drawing.

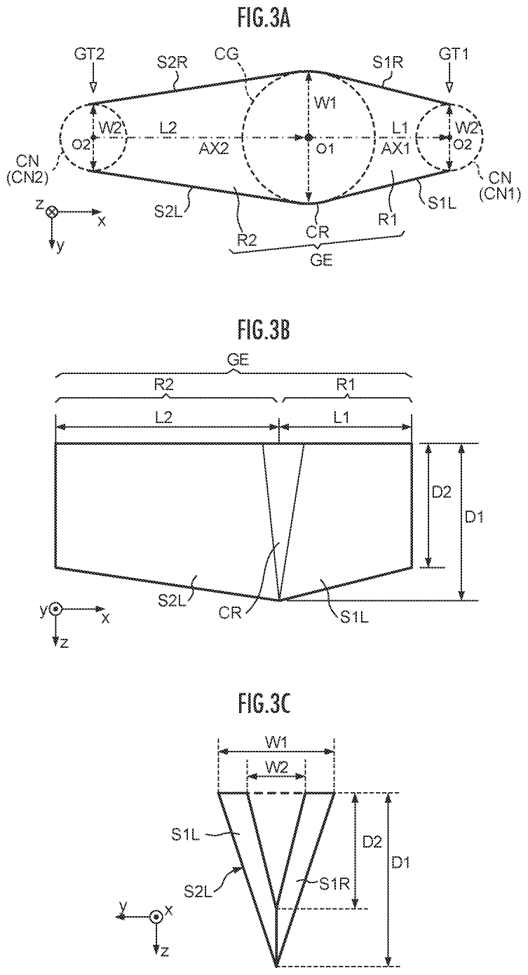

FIG. 3A is a top view of the groove element GE of a groove GR provided on a surface of a base material 11 in a case where the groove element GE is viewed in a direction perpendicular to the base material 11 (in a case of being viewed from the upper surface). FIG. 3B is a view schematically illustrating a side surface of the groove in a case where the groove element GE illustrated in FIG. 3A is viewed in a −y direction. In addition, FIG. 3C is a view schematically illustrating a cross section of the groove in a case where the groove element GE is viewed in a −x direction.

The first groove region R1 of the groove element GE has quadrangular groove wall surfaces S1R and S1L, and the second groove region R2 has quadrangular groove wall surfaces S2R and S2L. In addition, the first groove region R1 and the second groove region R2 are formed as a groove region in which the cross section has a V shape as illustrated in FIG. 3C.

The groove element GE has the conical groove region CR which is a part of a cone CG. It is noted that the cone CG has a bottom surface on the same surface as the surface of the base material 11. The groove wall surfaces S1R and S1L of the first groove region R1 and the groove wall surfaces S2R and S2L of the second groove region R2 in the groove element GE circumscribe the conical groove region CR from both sides of the conical groove region CR.

The groove element GE has a first end part GT1 which is one end part of the groove element GE and a second end part GT2 which is the other end part thereof. In the first end part GT1 of the groove element GE, the groove wall surfaces S1R and S1L of the first groove region R1 circumscribe a conical surface CN1 from both sides, the conical surface CN1 having a shape similar to the conical groove region CR (the cone CG) and having a size smaller than the conical groove region CR. It is noted that the conical surface CN1 has a bottom surface on the same surface as the surface of the base material 11.

In addition, In the second end part GT2 of the groove element GE, the groove wall surfaces S2R and S2L of the second groove region R2 circumscribe a conical surface CN2 from both sides, the conical surface CN2 having the same shape as the conical surface CN1 in the first end part GT1.

It is noted that the groove GR, which is obtained by sequentially connecting the first end part GT1 of one groove element GE to the second end part GT2 of another groove element to be linked in a row, is formed. Therefore, in the following description, the conical surface CN1 and the conical surface CN2 may be simply referred to as the conical surface CN, and the first end part GT1 and the second end part GT2 of the groove element GE may be simply referred to as the end part GT of the groove element GE, in a case where they are not necessary to be particularly distinguished.

It is noted that in the first embodiment, a direction (first direction) AX1 from a center O1 of a bottom surface of the conical groove region CR toward a center O2 of a bottom surface of the conical surface CN1 of the first end part GT1, and a direction (second direction) AX2 from a center O2 of a bottom surface of the conical surface CN2 of the second end part GT2 toward the center O1 of the bottom surface of the conical groove region CR are the same direction AX.

The first groove region R1 and the second groove region R2 have the same depth D1 as the conical groove region CR at a connection part connected to the conical groove region CR and have the same depth D2 as the conical surface CN at the first end part GT1 and the second end part GT2. It is noted that the conical groove region CR and the conical surface CN preferably have a right circular cone shape.

### (2) Requirement for Liquid Droplet Movement

As a result of studies and experiments, the inventor of the present application found that in a case where the groove structure described above is provided, and the first groove region R1 and the second groove region R2 of the groove element GE satisfy predetermined shapes and conditions, liquid droplets move in a predetermined direction in a fine groove. The shape and conditions of the groove element GE will be described in detail below.

As described above, the ease of movement of the fluid in the groove is associated with the groove width W and the outer peripheral length S of the groove in the cross section perpendicular to the axis of the groove regardless of the groove shape. That is, in a case where the first groove region R1 and the second groove region R2 satisfy a predetermined relationship, liquid droplets capable of being moved from the first groove region R1 to the second groove region R2 by a driving force DF due to the capillary phenomenon.

The conditions for the liquid droplet movement will be specifically described below. As described above, a direction AX1 from a center O1 of a bottom surface of the conical groove region CR toward a center O2 of a bottom surface of the conical surface CN1 of the first end part GT1 is denoted as the first direction, and a direction AX2 from a center O2 of a bottom surface of the conical surface CN2 of the second end part GT2 toward the center O1 of the bottom surface of the conical groove region CR is denoted as the second direction.

In addition, in a case where a length of the first groove region R1 in the first direction (AX1) and a length of the second groove region R2 in the second direction (AX2) are respectively denoted as L1 and L2, a diameter of the bottom surface of the conical groove region CR and a diameter of the bottom surface of the conical surface CN on the surface of the base material 11 are respectively denoted as W1 and W2, and a depth of the conical groove region CR and a depth of the conical surface CN are respectively denoted as D1 and D2, the groove element GE satisfies the following expressions,

$$L 1 < L 2 , \qquad Expression ( 1 )$$

$$W 1 > W 2 , \qquad Expression ( 2 )$$

$$D 1 > D 2 , and \qquad Expression ( 3 )$$

$$( D 2 / W 2 ) > ( D 1 / W 1 ) . \qquad Expression ( 4 )$$

It is noted that here, the length L1 of the first groove region R1 is a distance from the center O1 of the bottom surface of the conical groove region CR to the center O2 of the bottom surface of the conical surface CN1, and the length L2 of the second groove region R2 is a distance from the center O2 of the bottom surface of the conical surface CN1 to the center O1 of the bottom surface of the conical groove region CR.

In addition, the ranges of numerical values of L1, L2, W1, W2, D1, D2 are preferably ranges that satisfy,

$$\begin{matrix}30 μm < W 2 < W 1 \leq 100 μm , \\ 30 μm < L 1 < L 2 \leq 200 μm , and \\ 60 μm < D 2 < D 1 \leq 200 μm\end{matrix} . \qquad Expression ( 5 )$$

In each embodiment and each Example according to the present specification, those, which satisfy L1=40 μm, L2=160 μm, W1=40 μm, W2=80 μm, D1=80 μm, and D2=130 μm, are used.

Although the ranges of numerical values according to Expression (5) are described as preferred ranges of the ranges of numerical values of L1, L2, W1, W2, D1, and D2, they are not limited thereto. The range of the numerical value of each parameter may be any numerical range that satisfies the conditions for satisfying liquid droplet movement.

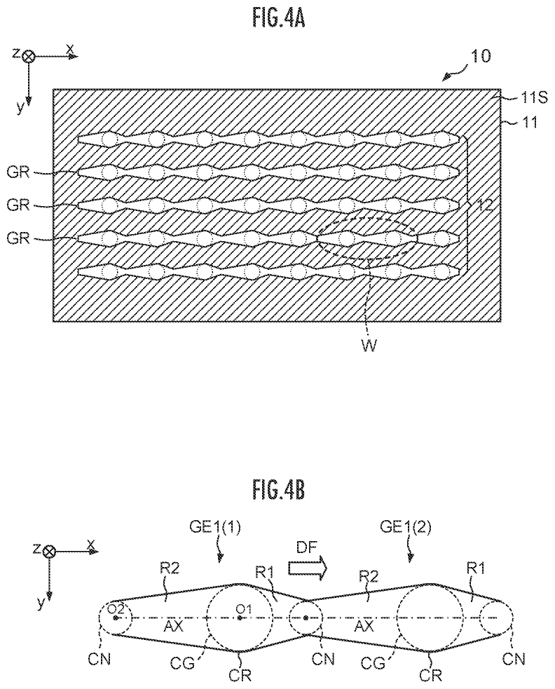

FIG. 4A is a top view schematically illustrating an upper surface of a molded structure body 10 according to the first embodiment of the present invention, and FIG. 4B is a partially enlarged view of a part of the groove GR formed on the surface of the molded structure body 10.

As illustrated in FIG. 4A, on a surface 11S of the base material 11 of the molded structure body 10, a plurality of fine grooves GR which are parallel to each other and extend in a predetermined direction (x direction) is formed, and a group of groove structures 12 is constituted. The plurality of the grooves GR are grooves that are arranged in the y direction and are dug in the z direction (depth direction).

The plurality of the grooves GR may be arranged in the y direction (arrangement direction) at regular intervals or may be arranged at different intervals.

As illustrated in FIG. 4B, each of the grooves GR has a structure in which two adjacent groove elements are repeatedly linked or connected in a predetermined direction. A groove element GE1 having the same structure as that according to the first embodiment (hereinafter, simply referred to as the groove element GE in a case of not being particularly distinguished) is linked in a predetermined direction (x direction). That is, the groove elements GE1 (1) and GE1 (2) are repeatedly and linearly linked along the same axial direction AX, whereby it is possible to constitute the groove GR in which the groove element GE is linearly linked in a row.

In a case where Expressions (1) to (4) described above are satisfied, the driving force DF due to the capillary phenomenon is exhibited, and thus the liquid droplets in the groove GR are such liquid droplets that are capable of being moved from the first groove region R1 of the groove element GE1 (1) to the second groove region R2 of the adjacent groove element GE1 (2). That is, in FIG. 4A, the liquid droplets that have adhered to the molded structure body 10 move in the right direction (the +x direction) by the capillary force and then are discharged.

### Second Embodiment

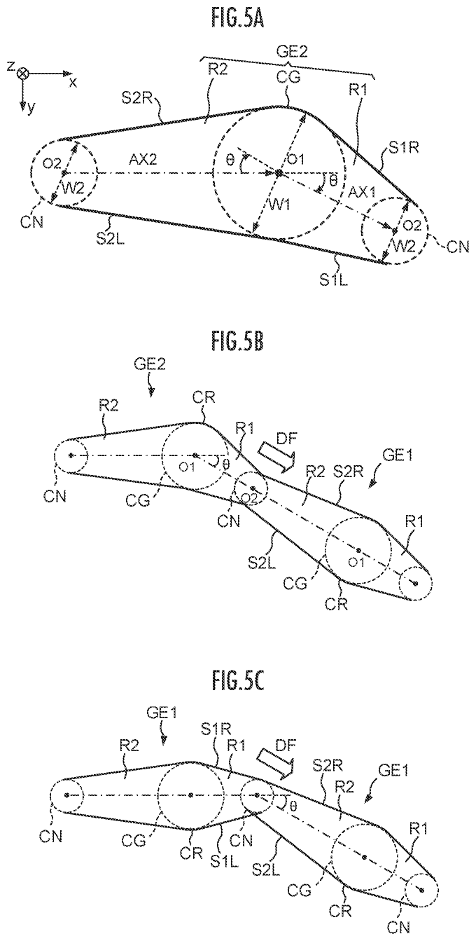

FIG. 5A is a schematic top view of the first groove region R1, the second groove region R2, and the conical groove region CR of the groove element GE2 according to a second embodiment of the present invention in a case of being viewed in a direction perpendicular to the base material 11 (in a case of being viewed from the upper surface).

In the groove element GE2 according to the second embodiment, the extending direction or the axial direction (first direction) AX1 of the first groove region R1 is tilted by a predetermined angle θ (0<θ) with respect to the axial direction (first direction) AX2 of the second groove region R2.

FIG. 5B is a top view illustrating a connection form in which a groove element GE2 according to the second embodiment and a groove element GE1 according to the first embodiment are connected to each other.

The groove element GE2 is connected to the second groove region R2 of the groove element GE1 by using, as a common circumscribed conical surface, the conical surface CN that is circumscribed to the groove wall surfaces S1R and S1L of the first groove region R1 of the groove element GE2 and the groove wall surfaces S2R and S2L of the second groove region R2 of the groove element GE1.

In a case of using the groove element GE2 and the groove element GE1 according to the second embodiment illustrated in FIG. 5A, it is possible to constitute the groove GR that is bent at any position, that is, at the center O1 of the cone CG of the conical groove region CR. Due to such a constitution, the liquid droplets that have adhered to the surface 11S of the base material 11 are guided by the exhibition of the driving force DF and move from the first groove region R1 of the groove element GE2 to the second groove region R2 of the adjacent groove element GE1.

FIG. 5C is a top view illustrating a connection form in which two groove elements GE1 according to the first embodiment are connected to each other.

The groove element GE2 is connected to the second groove region R2 of the groove element GE1 by using, as a common circumscribed conical surface, the conical surface CN that is circumscribed to the groove wall surfaces S1R and S1L of the first groove region R1 of the groove element GE1 and the groove wall surfaces S2R and S2L of the second groove region R2 of the groove element GE1.

In a case of using two groove elements GE1, it is possible to constitute the groove GR that is bent at the center O2 of the conical surface CN. Due to such constitution, the liquid droplets that have adhered to the surface 11S of the base material 11 are guided by the exhibition of the driving force DF and move from the first groove region R1 of the groove element GE1 to the second groove region R2 of the adjacent groove element GE1.

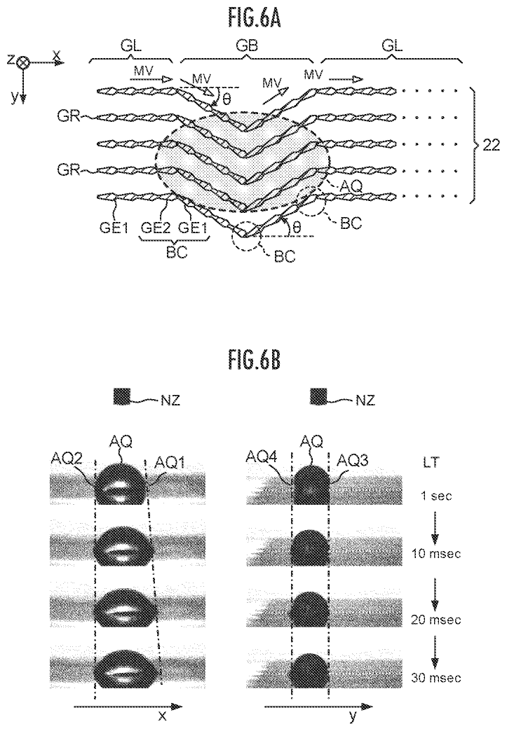

Example 1 (Ex. 1) will be described in detail with reference to FIG. 6A and FIG. 6B. The sample that constitutes Example 1 has been created by forming grooves in s substrate consisting of a polymethyl methacrylate resin (PMMA) according to laser processing.

In addition, for the observation of water droplets on a sample constituting Example 1, a contact angle meter (PCA-11, manufactured by Kyowa Interface Science Co., Ltd.) has been used, and each water droplet of 2 μl has been dropped from a nozzle NZ of the contact angle meter to carry out the observation.

FIG. 6A is a top view schematically illustrating a groove structure 22 of Example 1 (Ex. 1). The groove GR of Example 1 (Ex. 1) is constituted to have a bent groove part GB by connecting, at an angle θ, a groove portion (a linear groove part GL), in which a plurality of groove elements GE1 according to the first embodiment is linearly linked in a predetermined direction (x direction), to a linear groove portion consisting of at least one groove element GE1. It is noted that the guide direction MV of the liquid droplet is indicated by an arrow in the drawing.

It is noted that as illustrated in FIG. 5B, a connection portion (bent connection part) BC between the linear groove part GL and the bent groove part GB has a connection form due to the groove element GE2 according to the second embodiment and the groove element GE1 according to the first embodiment. However, the bent connection part BC may be constituted of two groove elements GE1. Alternatively, it may be constituted of two groove elements GE2, and the bent groove part GB may be formed.

The groove GR has the linear groove part GL that extends in the x direction and at least one bent groove part GB. In a case of Example 1 (Ex. 1), the groove GR has one bent groove part GB formed from three bent connection parts BC.

The bent groove part GB has a V shape in a case of being viewed in a direction perpendicular to the surface 11S of the base material 11 (in a case of being viewed from the upper surface). For example, the bending angle θ is 30°; however, it is not limited thereto. In addition, the bent groove part GB is preferably provided to be symmetrical with respect to the y direction; however, it may have an asymmetric V shape.

On the surface 11S of the base material 11, a plurality of the grooves GR is disposed in a direction (the y direction) perpendicular to the predetermined direction, and a group of groove structures 22 is constituted. In addition, a liquid droplet AQ dropped on the group of the groove structures 22 is schematically illustrated.

FIG. 6B illustrates observation images obtained by dropping a water droplet of 2 μl from the nozzle NZ on the groove structure 22 of Example 1 (Ex. 1) and observing a change of the dropped water droplet with a camera of a contact angle meter in an elongation direction (x direction) of the groove GR and a direction (y direction) perpendicular to the elongation direction. It is noted that the images are sequentially shown to be aligned so that the elapsed times LT after the dropping of the water droplet are 1 milliseconds (msec), 10 msec, 20 msec, and 30 msec.

As illustrated in FIG. 6B, the water droplet end part AQ1 on the +x side of the water droplet AQ moves with the elapse of time from the position immediately after the dropping (elapsed time LT=1 msec) toward the groove direction (+x direction), and almost no movement has been observed regarding the water droplet end part AQ2 on the −x side. On the other hand, no large movement has been observed in the y direction regarding the water droplet end parts AQ3 and AQ4.

FIG. 6C is a graph illustrating the measurement results of the contact angles φ of water droplet end parts AQ1 and AQ3 with respect to an elapsed time LT after the dropping of the water droplet, in Example 1 (Ex. 1). It is noted that the results of a plurality of times of measurements are shown.

The contact angles φ of the water droplet end parts AQ1 and AQ3 have been reduced with the elapse of time. In particular, it has been confirmed that the contact angle of the water droplet AQ1 which is the end part on the moving direction (+x direction) side is significantly reduced with the elapse of time.

As a result, it has been confirmed that the water droplet AQ is guided by the groove structure 22 and moves in a specific direction (the extending direction of the groove GR).

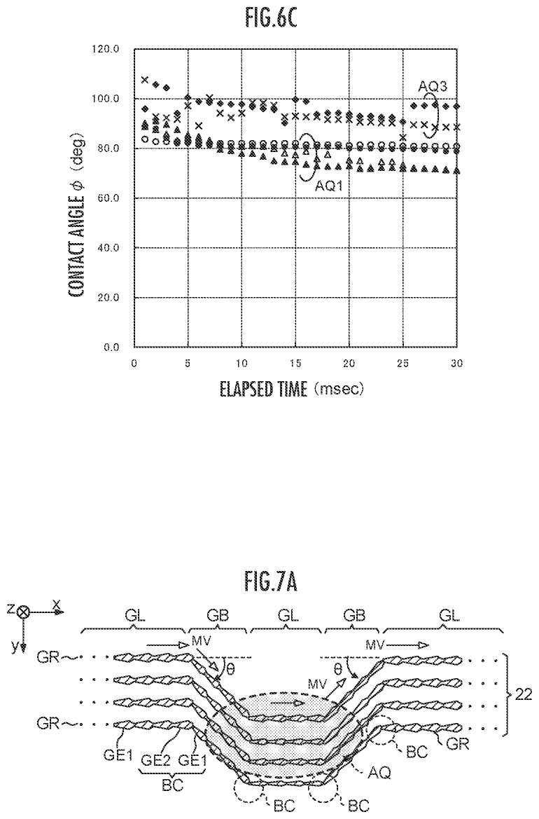

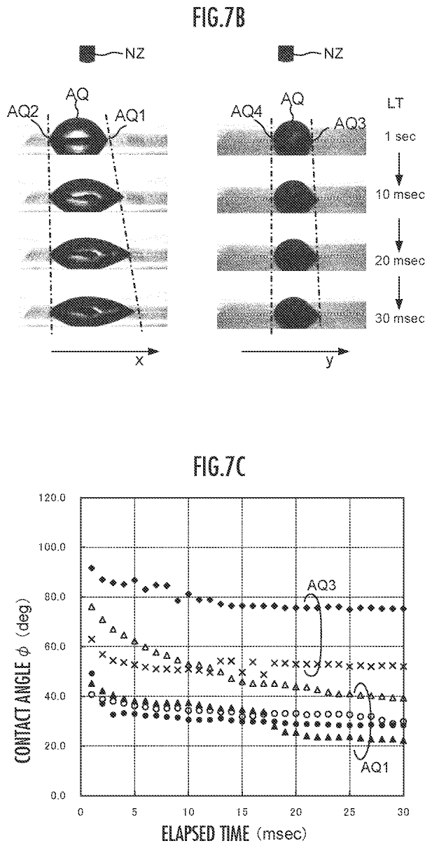

FIG. 7A is a top view schematically illustrating a groove structure 22 of Example 2 (Ex. 2). The groove GR of Example 2 (Ex. 2) is constituted by alternately connecting, at a bending angle θ, a plurality of the linear groove parts GL, in which a plurality of groove elements GE1 is linearly linked in a row in the moving direction (x direction) of the liquid droplet, to a plurality of the linear bent groove parts GB consisting of at least one groove element GE1.

The connection portion between the linear groove part GL and the bent groove part GB has the connection form illustrated in FIG. 5B. The bending angle θ between the linear groove part GL and the bent groove part GB is 45°; however, it is not limited thereto. In addition, the bent groove part GB is preferably provided to be symmetrical with respect to the y direction; however, it may have an asymmetric U shape.

FIG. 7B illustrates observation images obtained by dropping a water droplet of 2 μl from the nozzle NZ on the groove structure 22 of Example 2 (Ex. 2) and observing a change of the dropped water droplet with a camera.

The water droplet end part AQ1 on the +x side of the water droplet AQ moves with the elapse of time from the position immediately after the dropping (elapsed time LT=1 msec) toward the groove direction (+x direction), and almost no movement has been observed regarding the water droplet end part AQ2 on the −x side.

On the other hand, in the y direction, it has been confirmed that although no large movement has been observed regarding the water droplet end part AQ4 on the −y side, the water droplet end part AQ3 on the ty side moves in the +y direction.

FIG. 7C is a graph illustrating the results of a plurality of times of measurements of the contact angles q of water droplet end parts AQ1 and AQ3 with respect to the elapsed time LT after the dropping of the water droplet, in Example 2 (Ex. 2).

The contact angles q of the water droplet end parts AQ1 and AQ3 have been reduced with the elapse of time. In particular, it has been confirmed that the contact angle of the water droplet AQ1 which is the end part on the moving direction (+x direction) side is significantly reduced with the elapse of time.

As a result, it has been confirmed that the water droplet AQ is guided by the groove structure 22 and moves in a specific direction (the extending direction of the groove GR).

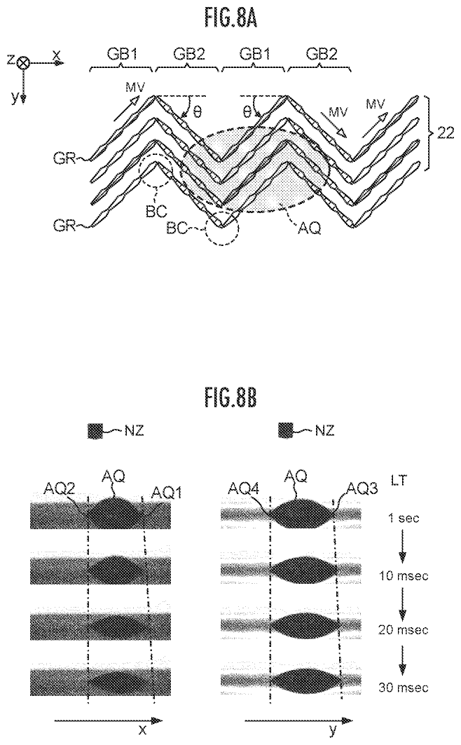

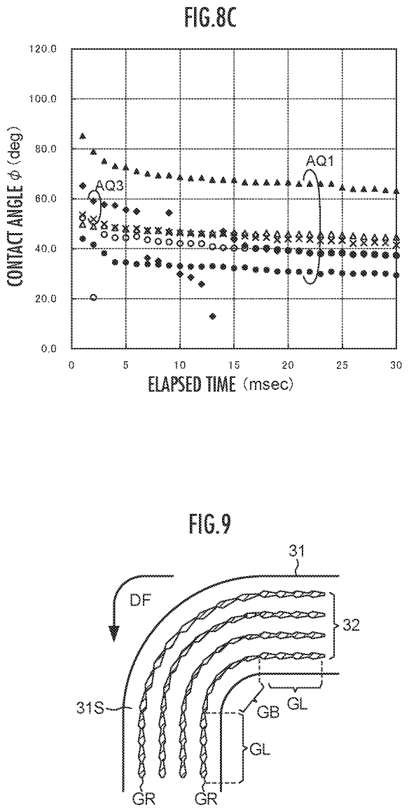

FIG. 8A is a top view schematically illustrating a groove structure 22 of Example 3 (Ex. 3). In the groove GR of Example 3 (Ex. 3), the bent groove parts GB1 and GB2 which are bent with respect to the moving direction (x direction) of the liquid droplets are alternately connected at an angle θ with respect to the extending direction (x direction) of the groove GR.

More specifically, the bent groove parts GB1 and GB2 are formed by linearly linking a plurality of the groove elements GE1. The bent connection part BC of the bent groove parts GB1 and GB2 has the connection form illustrated in FIG. 5B; the connection form is not limited thereto. It may be connected in the connection form illustrated in FIG. 5C. The angle θ is 45°; however, it is not limited thereto. In addition, although the form is preferably symmetrical with respect to the y direction, it may be an asymmetric form.

FIG. 8B illustrates observation images obtained by dropping a water droplet of 2 μl from the nozzle NZ on the groove structure 22 of Example 3 (Ex. 3) and observing a change of the dropped water droplet with a camera.

The water droplet end part AQ1 on the +x side of the water droplet AQ moves with the elapse of time from the position immediately after the dropping (elapsed time LT=1 msec) toward the groove direction (+x direction), and almost no movement has been observed regarding the water droplet end part AQ2 on the −x side.

On the other hand, in the y direction, The water droplet end part AQ3 on the +y side of the water droplet AQ moves toward the groove direction (+y direction), and almost no movement has been observed regarding the water droplet end part AQ4 on the −y side.

FIG. 8C is a graph illustrating the results of a plurality of times of measurements of the contact angles φ of water droplet end parts AQ1 and AQ3 with respect to the elapsed time LT after the dropping of the water droplet, in Example 3 (Ex. 3).

It has been confirmed that the contact angles φ of the water droplet end parts AQ1 and AQ3 are significantly reduced with the elapse of time.

As a result, it has been confirmed that the water droplet AQ is guided by the groove structure 22 and moves in a specific direction (the extending direction of the groove GR: x direction) and a direction (the y direction) perpendicular to the extending direction of the groove GR.

FIG. 9 is a top view schematically illustrating a groove structure 32 of Example 4 (Ex. 4). The groove structure 32 is formed on the surface of an inner wall 31S of a pipe 31 such as a heat pipe. The pipe 31 has a bent structure.

The groove structure 32 has the bent groove part GB in which a plurality of the groove elements GE is formed in a curved shape along a curve of the pipe 31 and the linear groove part GL which is formed along the linear part of the pipe 31. That is, the groove structure 32 is formed to extend along the elongation direction of the pipe.

More specifically, in the bent groove part GB, the groove GR is formed in a curved shape by connecting a plurality of the groove elements GE2. In this case, the liquid droplets that have adhered to the inner wall 31S of the pipe 31 move, due to the exhibition of the driving force DF, from the first groove region R1 of the groove element GE2 to the second groove region R2 of the adjacent groove element GE2.

It is noted that the groove GR may be constituted by connecting a plurality of the groove elements GE1, or the groove element GE1 and the groove element GE2.

According to the present embodiment, the groove GR is capable of being formed according to the shape of the base material, the liquid droplets are capable of being moved in any direction, and the liquid droplets are capable of being moved efficiently.

### Third Embodiment

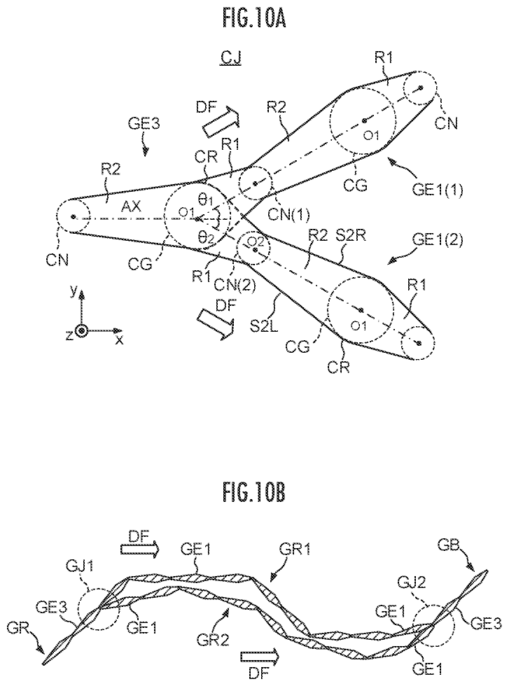

FIG. 10A is a view illustrating a connection form of a groove element GE3 according to a third embodiment of the present invention and is a schematic top view in a case of being viewed in a direction perpendicular to the base material 11 (in a case of being viewed from the upper surface).

The groove element GE3 according to the third embodiment has two or more first groove regions R1. In addition, the two first groove regions R1 of the groove element GE3 are connected to two groove elements GE1 (1) and GE1 (2) according to the first embodiment to constitute a branch connection GJ.

More specifically, the groove element GE3 is connected to the second groove region R2 of the groove element GE1 (1) by using, as a common circumscribed conical surface, the first conical surface CN (1) that is circumscribed to the groove wall surfaces S1R and S1L of one first groove region R1 of the groove element GE3 and the groove wall surfaces S2R and S2L of the second groove region R2 of the groove element GE1 (1). Further, the groove element GE3 is connected to the second groove region R2 of the groove element GE1 (2) by using, as a common circumscribed conical surface, the second conical surface CN (2) that is circumscribed to the groove wall surfaces S1R and S1L of the other first groove region R1 of the groove element GE3 and the groove wall surfaces S2R and S2L of the second groove region R2 of the groove element GE1 (2).

The groove element GE3 and the groove element GE1 (1) are connected to each other to be bent by an angle +θ1 (0<θ1) with respect to the axial direction (x direction) AX of the groove element GE3, and the groove element GE3 and the groove element GE1 (2) are connected to each other to be bent by an angle −θ2 (0 <θ2) with respect to the axial direction AX of the groove element GE2.

As a result, the two groove elements GE1 (1) and GE1 (2) branching from the groove element GE3 are formed, and thus a branch connection structure is capable of being formed. In the structure according to a third embodiment, by repeatedly forming a branch connection structure of the groove structure as illustrated in FIG. 10A, it is possible to increase the abundance proportion of the groove element as compared with a case where only a linear structure such as that in each of examples described above is formed in parallel, and further, a higher effect of discharging liquid droplets is provided. For example, as illustrated in FIG. 10A, each groove element is capable of being combined to form a molded structure body having a lattice-shaped groove shape.

FIG. 10B is a top view schematically illustrating two grooves GR1 and GR2 which are branched and bound by using the groove element GE3.

More specifically, the groove GR is branched into two grooves GR1 and GR2 (branch part GJ1) by the groove element GE3. Two grooves GR1 and GR2 are bound to one groove GR in a branch part GJ2.

In a case of using such a branch connection GJ, it is possible to provide a groove structure and a molded structure body, which enable liquid droplets to be efficiently moved in any direction.

It is possible to realize various groove structures in a case of appropriately modifying or combining the embodiments and examples described above.

As described in detail above, according to the present invention, it is possible to provide a molded structure body such as an optical component that has a high effect of discharging liquid droplets and has an excellent anti-fogging effect. In addition, it is possible to provide a molded structure body having a groove structure that enables liquid droplets to be efficiently moved in any direction.

### DESCRIPTION OF REFERENCE NUMERALS

10: molded structure body
11: base material
11S: surface of base material
12, 22, 32: groove structure
31: pipe
31S: inner wall of pipe
AQ: water droplet
CG: cone
CN, CN1,CN2: conical surface
CR: conical groove region
GB: bent groove part
GE1, GE2, GE3: groove element
GL: linear groove part
GR, GR1, GR2: groove
R1: first groove region
R2: second groove region

1. A molded structure body comprising:
a base material; and
at least one groove obtained by linking a plurality of groove elements each having a first end part and a second end part, on a surface of the base material in a row such that the first end part of one groove element is sequentially connected to the second end part of another groove element,
wherein each of the groove elements is composed of a first groove region in which a groove wall surface has a quadrangular shape and a cross section has a V shape, a conical groove region in which a groove wall surface has a conical shape, and a second groove region in which a groove wall surface has a quadrangular shape and a cross section has a V shape,
in the first groove region, at one end which is the first end part, the groove wall surface circumscribes a conical surface from both sides, the conical surface having a shape similar to the conical groove region and having a size smaller than the conical groove region, and at the other end, the groove wall surface circumscribes the conical groove region from both sides,
in the second groove region, at one end which is the second end part, the groove wall surface circumscribes the conical surface from both sides, and at the other end, the groove wall surface circumscribes the conical groove region from both sides,
the first groove region and the second groove region have a same depth as the conical groove region at a connection part connected to the conical groove region and have a same depth as the conical surface at the first end part and the second end part, and
in a case where a direction from a center of a bottom surface of the conical groove region toward a center of a bottom surface of the conical surface of the first end part is denoted as a first direction,
a direction from a center of a bottom surface of the conical surface of the second end part toward the center of the bottom surface of the conical groove region is denoted as a second direction,
a length of the first groove region in the first direction and a length of the second groove region in the second direction are respectively denoted as L1 and L2,
a diameter of the bottom surface of the conical groove region and a diameter of the bottom surface of the conical surface on the surface of the base material are respectively denoted as W1 and W2, and
a depth of the conical groove region and a depth of the conical surface are respectively denoted as D1 and D2, the groove element satisfies,
$$L 1 < L 2 , \qquad Expression ( 1 )$$
$$W 1 > W 2 , \qquad Expression ( 2 )$$
$$D 1 > D 2 , and \qquad Expression ( 3 )$$
$$( D 2 / W 2 ) > ( D 1 / W 1 ) . \qquad Expression ( 4 )$$

2. The molded structure body according to claim 1,
wherein in each groove element of the plurality of groove elements that constitute the at least one groove, an extending direction of the first groove region and an extending direction of the second groove region are the same direction.

3. The molded structure body according to claim 1,
wherein in the at least one groove, at least one of the groove elements of the groove has a bent connection part in which an extending direction of the first groove region is bent by a bending angle θ with respect to an extending direction of the second groove region.

4. The molded structure body according to claim 1,
wherein the at least one groove has a bent connection part in which the first groove region of one groove element that constitutes the groove and the second groove region of another groove element that is connected to the one groove element are bent to each other by a bending angle θ.

5. The molded structure body according to claim 1,
wherein in the at least one groove, at least one of the groove elements of the groove has two or more first groove regions, and
the two or more first groove regions are each connected to the other groove element to have a branched and bound structure.

6. The molded structure body according to claim 1,
wherein the molded structure body has a groove structure composed of a plurality of the grooves disposed on the surface of the base material to be parallel with each other.

7. The molded structure body according to claim 3,
wherein the molded structure body has a groove structure composed of a plurality of the grooves disposed on the surface of the base material to be parallel with each other, and
the groove has a plurality of the bent connection parts.

8. The molded structure body according to claim 1,
wherein the base material is a pipe, and
the surface of the base material is a surface of an inner wall of the pipe.

9. The molded structure body according to claim 8,
wherein the at least one groove extends along an elongation direction of the pipe.

10. The molded structure body according to claim 4,
wherein the molded structure body has a groove structure composed of a plurality of the grooves disposed on the surface of the base material to be parallel with each other, and
the groove has a plurality of the bent connection parts.
